(19) United States
(12) Patent Application Publication
(10) Pub. No.: US 2021/0116780 A1
(43) Pub. Date: Apr. 22, 2021

(54) METHOD AND APPARATUS FOR CONTROL AND DYNAMIC MANIPULATION OF ELECTRO-MAGNETIC WAVE SPECTRUM VIA EXTERNAL MODULATION OF REFRACTIVE INDEX

(71) Applicant: Signature Science, LLC, Austin, TX (US)

(72) Inventors: Vladimir Semak, Pine Grove Mills, PA (US); Mikhail Shneider, Princeton, NJ (US)

(21) Appl. No.: 16/604,415

(22) PCT Filed: Apr. 10, 2018
(86) PCT No.: PCT/US18/26979

§ 371 Date: Oct. 10, 2019

Related U.S. Application Data
(60) Provisional application No. 62/483,612, filed on Apr. 10, 2017.

(51) Int. Cl. G02F 1/35

(52) U.S. Cl. CPC G02F 1/3511; G02F 1/3515

(57) ABSTRACT

A method is provided for modifying a wavelength of electromagnetic radiation that propagates through a medium. The method includes providing a medium that exhibits a change in refractive index in response to a change in electric field; impinging electromagnetic radiation from a electromagnetic radiation source onto the medium such that the electromagnetic radiation propagates through the medium; and modifying at least one wavelength of the electromagnetic radiation propagating through the medium by externally inducing a temporal change in the refractive index of the medium.

### CROSS-REFERENCE TO RELATED APPLICATIONS

The present application is a national stage filing of PCT/US2016/016754, filed on Feb. 5, 2016, having the same title, the same inventor, and which is incorporated herein by reference in its entirety, which claims the benefit of priority from U.S. Provisional Application No. 62/483,612, filed on Apr. 10, 2017, which has the same title and the same inventors, and which is incorporated herein by reference in its entirety.

### FIELD OF THE DISCLOSURE

The present disclosure relates generally to electromagnetic wave spectroscopy, and more particularly to a method and apparatus for the control and dynamic manipulation of electromagnetic wave spectra via external modulation of refractive index.

### BACKGROUND OF THE DISCLOSURE

At present, various methods are utilized in the art for manipulation of the spectral output of high power or high pulse energy lasers. Such methods include frequency doubling in nonlinear crystals, self-phase modulation and the use of optical parametric oscillators.

Optical parametric oscillators utilize an optical resonator and a non-linear optical crystal, and oscillate at optical frequencies. These oscillators convert an input laser wave or “pump” with frequency ωₚ into two output waves (called the “signal” and “idler”) of lower frequency (ωₛ, ωᵢ) by means of second-order nonlinear optical interaction. The sum of the frequencies of the output waves is equal to the input wave frequency (that is, ωₛ+ωᵢ=ωₚ).

Frequency doubling (which is also called second-harmonic generation) refers to the phenomenon where an input (pump) wave generates another wave with twice the optical frequency (and half the vacuum wavelength) in the medium. Frequency doubling may be achieved with nonlinear crystals (that is, crystalline materials which lack inversion symmetry). Such crystals may be formed, for example, from lithium niobate (LiNbO₃), potassium titanyl phosphate (KTP=KTiOPO₄), and lithium triborate (LBO=LiB₃O₅). Typically, the pump wave is delivered in the form of a laser beam, and the frequency-doubled (second-harmonic) wave is generated in the form of a beam propagating in a similar direction.

Self-phase modulation is a non-linear optical effect resulting from the interaction of light with matter. In particular, when an ultrashort pulse of light travels in a medium, it will induce a varying refractive index in the medium as a result of the Kerr effect (the Kerr effect, which is also called the quadratic electro-optical effect, refers to a change in the refractive index of a material in response to an applied electric field). This variation in refractive index produces a phase shift in the pulse, thus leading to a change in the frequency spectrum of the pulse.

### SUMMARY OF THE DISCLOSURE

In one aspect, a method is provided for modifying a wavelength of electromagnetic radiation that propagates through a medium. The method comprises (a) providing a medium that exhibits a change in refractive index in response to a change in electric field; (b) impinging electromagnetic radiation from an electromagnetic radiation source onto the medium such that the electromagnetic radiation propagates through the medium; and (c) modifying at least one wavelength of the electromagnetic radiation propagating through the medium by externally inducing a temporal change in the refractive index of the medium.

In another aspect, a device is provided for producing electromagnetic radiation of variable frequency. The device comprises (a) a medium that exhibits a change in refractive index in response to a change in electric field; (b) a source of electromagnetic radiation which is in optical communication with said medium such that electromagnetic radiation from the source propagates through the medium; and (c) a means for externally inducing a temporal change in the refractive index of the medium such that the frequency of electromagnetic radiation propagating through the medium is modified.

### BRIEF DESCRIPTION OF THE DRAWINGS

FIG. 1 is a graph of the angle of inclination of the amplitude vector \vec{A} relative to the beam axis which was generated by solving EQUATIONS 3-5 to describe the dynamic characteristics of supercontinuum formation in air produced by a 100 fs laser pulse.

FIG. 2 is a graph of laser frequency shift which was generated by solving EQUATIONS 3-5 to describe the dynamic characteristics of supercontinuum formation in air produced by a 100 fs laser pulse.

FIG. 3 is a diagram of a device which may be utilized in some of the embodiments disclosed herein.

FIG. 4 depicts the relative time durations and the frequency change induced by the system of FIG. 3, and in particular, shows the laser pulse, voltage pulse ramp up, and time propagation through the crystal, with the expected change in laser frequency and pulse shape.

### DETAILED DESCRIPTION

While the aforementioned methodologies for manipulating the spectral output of high power or high pulse energy lasers may have some desirable attributes, there is still a need in the art for further advances in the control and manipulation of the spectrum of electro-magnetic waves (EMW). In particular, in many cases, the only method available for generating EMWs with the required properties produces waves with spectral outputs that are not optimal for some applications.

For example, in a laser generator, the available wavelengths of the laser radiation are limited to a number of specific, relatively narrow spectral bands, due to the physical nature of the laser emission. This limitation becomes even more restrictive if a high power or high pulse energy output is required.

For example, typical high power or high pulse energy lasers operate at wavelengths within the 9-11 μm, 0.8-1.6 μm, 532 nm, 355 nm, and 199-308 nm spectral regions. The width of the spectral output of a typical laser is relatively narrow, ranging from tens of kHz to hundreds of GHz. Indeed, the narrow bandwidth of laser output is one of distinctive properties of a laser that allows near diffraction limited focusing (i.e., the spot diameter of a laser beam is almost as small as the limit dictated by the associated physics). Hence, many applications would greatly benefit if the laser output was at a different and variable central wavelength, and if the bandwidth of the laser spectral output was variable (and preferably, significantly wider).

Unfortunately, optical parametric oscillation produces a narrow spectral output with the center wavelength shifted by approximately factor of 2 towards the shorter wavelength. Similarly, frequency doubling in nonlinear crystals produces a narrow spectral output in which the center wavelength is shifted towards the longer wavelength by a factor that depends on the properties of the nonlinear crystal.

Self-phase modulation allows for a continuous shift of the laser output. In this method, the wavelength shift is induced by the laser pulse itself due to nonlinear interaction with the material of the crystal. The range of wavelength spread depends on the crystal properties and on the laser beam intensity. In order to achieve noticeable wavelength shifts using self-phase modulation, laser intensities exceeding ˜10¹³ W/cm² are typically required. Thus, this method is applicable for lasers producing 0.1-1 mJ pulse energies with pulse durations in the range of picoseconds and less.

In theoretical works considering self-induced nonlinear optical effects, a relationship is deduced that describes changes in the EMW frequency as a result of changes in refractive index. The change of the EMW frequency while propagating a distance dz in the medium is described by EQUATION 1 below:

$${d}_{d z} ω = - \frac{2 π}{{λ}_{0}} \frac{d n ( z )}{d t} d z , \qquad ( EQUATION 1 )$$

where n(z) is the index of refraction, t is time, and λ₀ is the EMW wavelength in a vacuum. This equation is used in nonlinear optics to compute the laser frequency shift due to changes of the refractive index as a function of laser beam intensity.

To date, it has always been assumed that the change in refractive index in self-induced nonlinear optical effects are themselves self-induced (i.e., that “self-induced phase modulation” occurs). However, in the theoretical considerations giving rise to EQUATION 1, the cause of the change in refractive index is not actually specified.

The present investigators have found that the change in refractive index may not only be self-induced, but may be externally induced as well. In particular, the present investigators have found that any process that induces a temporal variation in the index of refraction may result in the EMW frequency shift, and hence may be utilized to modify the shape of EMW spectrum. Such processes include, for example, electro-magnetic effects, thermal effects, mechanical effects, or various combinations of the foregoing. It will thus be appreciated that externally induced phase modulation may be utilized to produce modifications in the spectrum of electro-magnetic waves.

Accordingly, methods are disclosed herein for shifting or sweeping the wavelength of a laser within a large spectral range from UV to IR while maintaining coherency of the laser beam and its energy/power. Simulations of the laser frequency shift during laser beam propagation in a medium with externally induced change of refractive index may be utilized to derive optimal parameters of the nonlinear crystal and high voltage pulses. Devices may be produced in accordance with the teachings herein that shift the wavelength of any pulsed laser in the range of +/−200 nm or more.

Currently, change of laser wavelength is achieved by using either Optical Parametric Oscillation/Amplification (OPO/OPA), semiconductor or liquid dye tunable lasers, or by cutting the desired part of the spectrum from the “white light” generated by an ultrashort pulse laser. However, these approaches, which are utilized primarily in laboratory environments, have serious shortcomings. In particular, they yield very small output energy/power and relatively low conversion efficiency, and are costly to implement.

Systems and methodologies are disclosed herein in which the wavelength shift of the laser is achieved by external modulation of the refractive index of a nonlinear crystal in which the laser beam propagates. This approach may be applied to any pulsed laser with any beam quality and any pulse energy. Unlike a self-induced nonlinear process, this approach does not require phase matching and high laser beam intensity. Moreover, in a preferred embodiment, this approach is equivalent to the use of many different laser systems operating at various wavelengths. Some of the technical underpinnings of this approach are described below.

The electromagnetic wave (EMW) propagation equation can be rewritten as follows:

$$Δ \vec{E} = - \frac{{n}^{2}}{{c}^{2}} \frac{{\partial }^{2} \vec{E}}{\partial {t}^{2}} - ∇ ( ∇ * \vec{E} ) = 0 \qquad ( EQUATION 2 )$$

It is usually assumed that the third term in EQUATION 2 is negligibly small. However, the present investigators have found that retaining this term is more accurate and leads to a different equation of EMW propagation in media with an inhomogeneous refractive index, which is given as EQUATION 3:

$${\sum }_{m = x , y , z} [ Δ {A}_{m} + 2 i ( {k}_{m} \frac{\partial {A}_{m}}{\partial x} + {k}_{y} \frac{\partial {A}_{m}}{\partial y} + {k}_{z} \frac{\partial {A}_{m}}{\partial z} ) - i ( \frac{\partial {k}_{x}}{\partial x} + \frac{\partial {k}_{y}}{\partial y} + \frac{\partial {k}_{z}}{\partial z} ) {A}_{m} + 2 i ( x \frac{\partial {k}_{x}}{\partial x} \frac{\partial {A}_{m}}{\partial x} + y \frac{\partial {k}_{y}}{\partial y} \frac{\partial {A}_{m}}{\partial y} + z \frac{\partial {k}_{z}}{\partial z} \frac{\partial {A}_{m}}{\partial z} ) - i ( x \frac{{\partial }^{2} {k}_{x}}{\partial {x}^{2}} + y \frac{{\partial }^{2} {k}_{y}}{\partial {y}^{2}} + z \frac{{\partial }^{2} {k}_{z}}{\partial {z}^{2}} ) {A}_{m} + 2 ( x {k}_{z} \frac{\partial {k}_{x}}{\partial x} + y {k}_{y} \frac{\partial {k}_{y}}{\partial y} + z {k}_{z} \frac{\partial {k}_{z}}{\partial z} ) {A}_{m} + ( {{x}^{2} ( \frac{\partial {k}_{x}}{\partial x} )}^{2} + {{y}^{2} ( \frac{\partial {k}_{y}}{\partial y} )}^{2} + {{z}^{2} ( \frac{\partial {k}_{z}}{\partial z} )}^{2} ) {A}_{m} ] \hat{m} - 2 [ ∇ ( \frac{∇ n}{n} \cdot ( \vec{A} {e}^{i ( {k}_{x} x + {k}_{y} y + {k}_{z} z )} ) ) ] {e}^{- i ( {k}_{x} x + {k}_{y} y + {k}_{z} z )} = 0 \qquad ( EQUATION 3 )$$

Solving EQUATION 3 and adding the phase term provides the complete solution:

$$\vec{E} = \vec{A} cos ( Φ ) = \vec{A} cos ( {ω}_{0} t - \frac{2 π n}{{λ}_{o}} z ) \qquad ( EQUATION 4 )$$

where \vec{A} is the electric field amplitude, Φ is the phase, ω₀ is the frequency of the wave in a vacuum, λ₀ is the wavelength in a vacuum, t is the time, z is the coordinate, and n is the refractive index of the medium. The frequency of the EMW, defined as the time derivative of the phase, is changing if the refractive index is changing in time, n(t):

$$ω = {ω}_{0} + d ω = {ω}_{0} - \frac{2 π}{{λ}_{0}} \frac{d n ( t )}{d t} d z \qquad ( EQUATION 5 )$$

where λ₀ is the EMW wavelength in a vacuum.

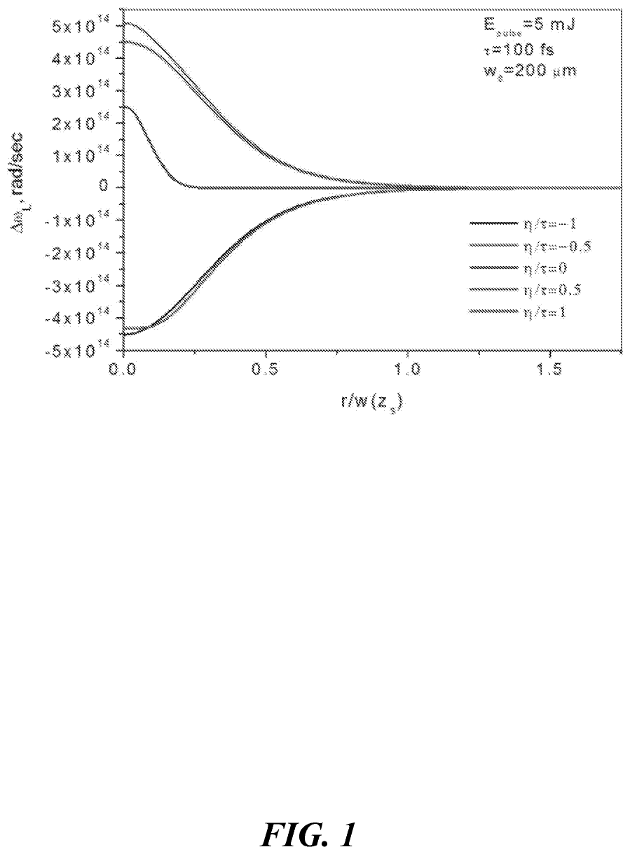

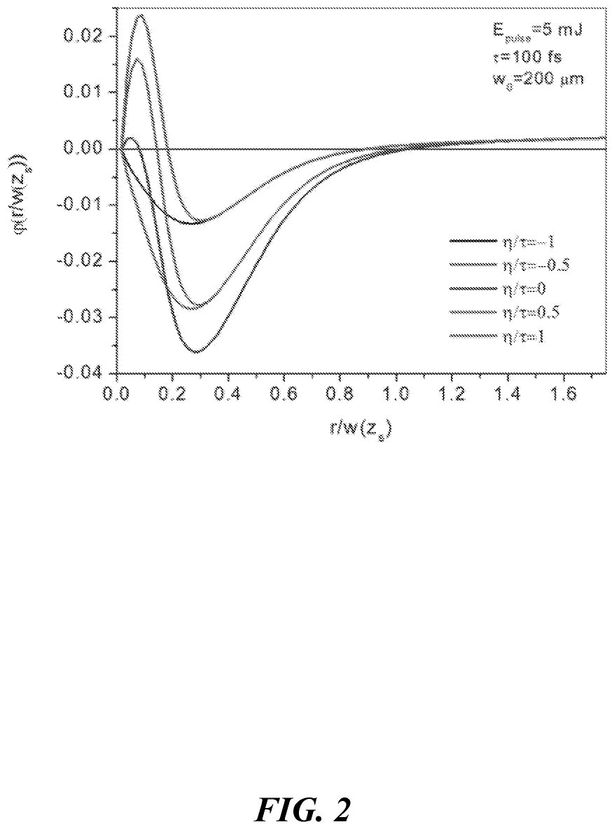

Suitable software may be written which solves the system described by EQUATIONS 3-5. By way of example, FIGS. 1-2 were generated by solving these equations to describe the dynamic characteristics of supercontinuum formation in air produced by a 100 fs laser pulse. FIG. 1 depicts the angle of inclination of the amplitude vector \vec{A} relative to the beam axis. FIG. 2 depicts the laser frequency shift.

The theoretical foundation of the methods proposed herein for frequency shift due to external modulation of refractive index stems from EQUATION 5. It follows from this equation that the change of the EMW frequency while propagating a distance dz in the media with refractive index that varies with time is:

$$d {ω}_{K el} = - \frac{2 π}{{λ}_{0}} \frac{d n}{d t} d z \qquad ( EQUATION 6 )$$

Usually, the change of laser frequency is assumed to be due to the self-induced change of the refractive index. The externally induced change of the refractive index is considered mainly in the description of phase modulators and change of polarization. The idea that externally induced changes of refractive index can produce large changes in the EMW frequency was neither considered nor practically implemented.

The External temporal variation of the refractive index resulting in the shift and change of EMW spectrum may be appreciated by suitable modification to EQUATION 6 as shown in EQUATION 7 below:

$$d {ω}_{K e l} = - \frac{2 π}{{λ}_{0}} \frac{d n}{d t} d z = - \frac{2 π}{{λ}_{0}} \frac{d z}{d t} d n = - \frac{2 π}{{λ}_{0}} \frac{c}{n} d n = {ω}_{0} \frac{d n}{n} \qquad ( EQUATION 7 )$$

It is known that the index of refraction can be changed due to various external effects. Here, it is proposed to apply a high voltage pulse, Eₑₓₜ(t), to a crystal that exhibits Pockels effect described by EQUATION 8:

n=n₀+rn₀³Eₑₓₜ(t) (EQUATION 8)

where n₀ is the index of refraction of a material in the absence of the electric field and r is the constant for nonlinear response of the crystal to the electric field. Substituting EQUATION 8 into EQUATION 7 yields:

$$d {ω}_{K e l} = - {ω}_{0} \frac{{rn}_{0}^{3} d {E}_{e x t} ( t )}{{n}_{0} + {rn}_{0}^{3} d {E}_{e x t} ( t )} \qquad ( EQUATION 9 )$$

If it is assumed that the externally applied electric field grows linearly as a function of time, then

$${E}_{e x t} ( t ) = \frac{{E}_{0}}{{T}_{0 va r}} ( t + τ ) = \frac{{U}_{0}}{a {T}_{0 var}} ( t + τ ) \qquad ( EQUATION 10 )$$

where E₀ and U₀ are the electric field and voltage amplitude, a is the distance between the electrodes, the delay time τ describes the moment when the EMW (or laser) pulse enters the refracting medium and T₀ᵥₐᵣ is the electric pulse length. The electric pulse length should be equal to or larger than the sum of the propagation time,

$${T}_{p} = \frac{L {n}_{0}}{c} ,$$

and the laser pulse duration, τₚ:

$${T}_{0 va r} {T}_{0 va r} \geq {T}_{p} + {τ}_{p} = \frac{{Ln}_{0}}{c} + {τ}_{p} \qquad ( EQUATION 11 )$$

Substituting EQUATION 10 into EQUATION 9 and rearranging yields:

$$\frac{d {ω}_{Kel}}{{ω}_{0}} = \frac{r {n}_{0}^{2} \frac{{E}_{0}}{{T}_{0 var}} d t}{{n}_{0} + r {n}_{0}^{2} \frac{{E}_{0}}{{T}_{0 var}} ( t + τ )} = \frac{r {n}_{0}^{2} \frac{{U}_{0}}{a {T}_{0 var}} d t}{{n}_{0} + r {n}_{0}^{2} \frac{{E}_{0}}{a {T}_{0 var}} ( t + τ )} \qquad ( EQUATION 12 )$$

It will be appreciated from the foregoing that the center wavelength of the laser line will be shifted toward lower frequencies (red shift) for an increasing electric field and shifted toward higher frequencies (blue shift) for decreasing electric field. Integration of EQUATION 12 from t=0 to exit time

$$t = {T}_{p} = \frac{L {n}_{0}}{c}$$

gives the frequency shift Δω_{Kel}:

$$\frac{Δ {ω}_{Kel}}{{ω}_{0}} = {\int }_{0}^{\frac{L {n}_{0}}{c}} \frac{d {ω}_{Kel}}{{ω}_{0}} = {\int }_{0}^{\frac{L {n}_{0}}{c}} - \frac{{rn}_{0}^{2} \frac{{E}_{0}}{{T}_{0 v a r}} d t}{{n}_{0} + {rn}_{0}^{2} \frac{{E}_{0}}{{T}_{0 v a r}} ( t + τ )} = ln ( \frac{1 + {rn}_{0}^{2} \frac{{U}_{0} τ}{a \frac{L {n}_{0}}{c} + τ}}{1 + {rn}_{0}^{2} \frac{{U}_{0}}{a}} ) \qquad ( EQUATION 13 )$$

EQUATION 13 can be approximated as follows:

$$\frac{Δ {ω}_{K e l}}{{ω}_{0}} \approx - r {n}_{0}^{2} \frac{{U}_{0}}{a} ( 1 - \frac{τ}{\frac{L {n}_{0}}{c} + τ} ) = - r {n}_{0}^{2} \frac{{U}_{0}}{a} ( 1 - \frac{\frac{L {n}_{0}}{c}}{\frac{L {n}_{0}}{c} + τ} ) \qquad ( EQUATION 14 )$$

where τ is within the segment [0, τₚ]. If the time of propagation of EMW through the length of the refractive medium is much longer than the pulse duration τₚ, the frequency shift is the largest:

$$\frac{Δ {ω}_{Kel}}{{ω}_{0}} \approx r {n}_{0}^{2} \frac{{U}_{0}}{a} . \qquad ( EQUATION 15 )$$

Otherwise, the shift of the frequency is smaller by a factor of approximately

$$\frac{\frac{L {n}_{0}}{c}}{τ} ≪ 1.$$

The latter conditions are typical for the phase modulation that is dramatically different from the method of frequency shift proposed herein. Thus, from EQUATION 14, it follows that the shift of laser frequency will have maximum value:

$$Δ {ω}_{Kel}^{max} \approx - {ω}_{0} r {n}_{0}^{2} {E}_{0 e x t} = {ω}_{0} r {n}_{0}^{2} \frac{{U}_{0}}{a} \qquad ( EQUATION 16 )$$

Then, the corresponding increase of the wavelength will be given by formula

$$Δ λ = {λ}_{0} r {n}_{0}^{2} \frac{{U}_{0}}{a} \qquad ( EQUATION 17 )$$

where λ₀ is the laser wavelength in a vacuum.

Using EQUATION 17, an estimate may be obtained for the shift of the laser wavelength expected from a device that will utilize commonly available technology. For lithium niobate (LiNbO₃), the electro-optical coefficient at the wavelength of λ₀=632 nm is r=31×10⁻¹² m/V, and the refractive index is n₀=2.28. For a high voltage pulse producing amplitude U₀=1 MV and for the thickness of the LiNbO₃ crystal a=5 mm, the shift of the laser wavelength will be

$$Δλ = {λ}_{0} r {n}_{0}^{2} \frac{{U}_{0}}{a} = ( 632 nm ) ( 31 \times {10}^{- 12} m \text{/} V ) {( 2.28 )}^{2} ( 1 {0}^{6} V \text{/} {5}^{- 3} m ) \approx \pm 20 nm \qquad ( EQUATION 18 )$$

For λ0=1064 nm, taking into account dispersion and assuming similar Pockels coefficient, the shift of the laser wavelength will be

$$Δ λ = {λ}_{0} r {n}_{0}^{2} \frac{{U}_{0}}{a} = ( 1064 nm ) ( 31 \times {10}^{- 12} m \text{/} V ) {( 2.24 )}^{2} ( 1 {0}^{6} V \text{/} {5}^{- 3} m ) \approx \pm 33 nm \qquad ( EQUATION 19 )$$

The systems disclosed herein may utilize multiple crystals. After propagation through n crystals, the output laser wavelength will be

$${λ}_{n} = {{λ}_{0} ( 1 + r {n}_{0}^{2} \frac{{U}_{0}}{a} )}^{n} \qquad ( EQUATION 20 )$$

Then, for the same laser wavelength of 632 nm, the maximum change of the laser wavelength Δλ=203 nm. Hence, the wavelength may be selected continuously in the range from 632 nm to 835 nm.

Various considerations may govern the crystal design in the devices and methodologies disclosed herein. For example, for a laser pulse duration t=10 ps, the required optical path inside of the crystal is preferaby larger than approximately

$$Z \approx \frac{c}{{n}_{0}} τ = \frac{3 * 1 {0}^{8} m \text{/} s}{2.28} 1 {0}^{- 11} s = 1.3 \; 1 mm \qquad ( EQUATION 21 )$$

An optical path length of 13.1 cm corresponds to a propagation time that is 100 times larger than the 10 ps pulse duration and matches a 1 ns pulser raise time. For a zig zag beam path in a crystal of length L=3 cm, this will require N=Z/L=5 passes. The width of the crystal, W, accommodating 5 passes should be W>N×2s. For laser beam radius s˜1 mm, the required width W>10 mm. It is well within the current technological capabilities to grow LiNbO₃ crystals of required orientation and size L×W×D=30 mm×10 mm×5 mm.

For a laser pulse duration τ=10 ns, the required optical path inside of the crystal should be larger than approximately

$$Z \approx \frac{c}{{n}_{0}} τ = \frac{3 * 1 {0}^{8} m \text{/} s}{2.28} 1 {0}^{- 8} s = 1.31 m \qquad ( EQUATION 22 )$$

If the optical propagation length in the crystal is 5.65 m, the propagation time is 5 times larger than the laser pulse duration.

For an unoptimized zig zag shape of the laser beam path in a crystal of length L=6 cm, N=Z/L passes are required (that is, N˜22). In that case, the width of the crystal, W, should be approximately W=N×2σ, where σ is the laser beam radius. For laser beam radius σ˜1 mm, the required width of the nonlinear crystal should be larger than 4.4 cm. It is well within the current technological capabilities to grow LiNbO₃ crystals of required orientation and size L×W×D=6 cm×5 cm×0.5 cm.

For LiNbO₃, ϵ˜5, then for S=2 cm² electrode area and crystal thickness a=0.5 cm, the capacitance will be C=8.85 10⁻¹²×5×2 10⁻⁴/5 10⁻³=1.77 10⁻¹² F and the current Iₐ=CUₘₐₓ/tau˜210 A. The peak power on the load will then be Pₚₑₐₖ≈UaIa≈25 MW. For an RFP=1 kHz repetition rate, the average power consumption will be Pav≈Pmax×tau×RPF=2510⁶×10⁻⁹×1000=25 W.

A first particular, non-limiting embodiment of the methodology disclosed herein involves the external modulation of refractive index with an electric field. In this embodiment, a laser beam is transmitted through a (typically crystalline) material that exhibits changes in refractive index in response to changes in an applied electric field (that is, the material exhibits the Pockels or Kerr electro-optic effect). Application of a controlled variable voltage to the lateral sides of the material will produce a variable electric field inside of the material, thus resulting in controlled manipulation of the spectrum of the laser radiation on output from the material. Since, at any given moment, the wave front of the laser beam on the output from the material has a high degree of spatial and temporal coherence that is similar to these properties in the original laser beam, the ability to focus the spectrally modified beam into a small spot will be retained.

For example, in such an embodiment, if the electric field applied is linearly time dependent, the output spectrum will have the same shape as the input spectrum (that is, the spectrum of the laser beam at the input of the device). However, compared to the input spectrum, the output spectrum will be shifted towards lower frequencies (that is, the output spectrum will undergo a red shift) for a linearly increasing electric field, and towards higher frequencies (that is, the output spectrum will undergo a blue shift) for a linearly decreasing electric field. In this case, during the time (T) of light propagation through the optical path (Z) inside of the crystal, the light frequency will change in accordance with EQUATION 2:

Δω=ω₀rn₀²E, (EQUATION 23)

where ω₀ is the original frequency, r is the constant for the nonlinear response of the crystal to the electric field, and n₀ is the refractive index of the crystal without electric field. This equation is deduced for the crystal in which the refractive index change depends on the applied electric field according to EQUATION 24:

Δn=rn₀³E (EQUATION 24)

If the applied electric field both increases and decreases during laser propagation in the material, the central frequency of the output laser beam will scan first toward the red portion of the spectrum, and then toward the blue portion of the spectrum. When the laser frequency shift covers the optical range and the variation in the electric field occurs faster that the response time of the detector (for example, the human eye), the observer will perceive the illumination as white light. However, the ability to focus such quasi-white light will be same as for focusing a coherent laser beam.

A second particular, non-limiting embodiment of the methodology disclosed herein involves the external mechanical modulation of the refractive index of a material. In such an embodiment, a laser beam may be transmitted through a medium that exhibits photoelasticity (that is, a change of refractive index as a function of mechanical strain). In such an embodiment, an acoustic or shock wave will transversely propagate through the laser beam, thereby producing a variation of refractive index and inducing a change in the spectrum of the output laser beam.

A third particular, non-limiting embodiment of the methodology disclosed herein involves the external electric modulation of refractive index of a medium placed in front of a LIDAR (Light Detection and Ranging) system. A controlled change in the electric field applied to the medium may be utilized to produce a shift (at LIDAR frequencies) in the emission spectrum. This arrangement may be utilized to provide hyperspectral detection (that is, detection at multiple frequencies). Such detection may be useful to thwart certain stealth technologies, or to provide detection in various atmospheric conditions (for example, during rain or sand storms).

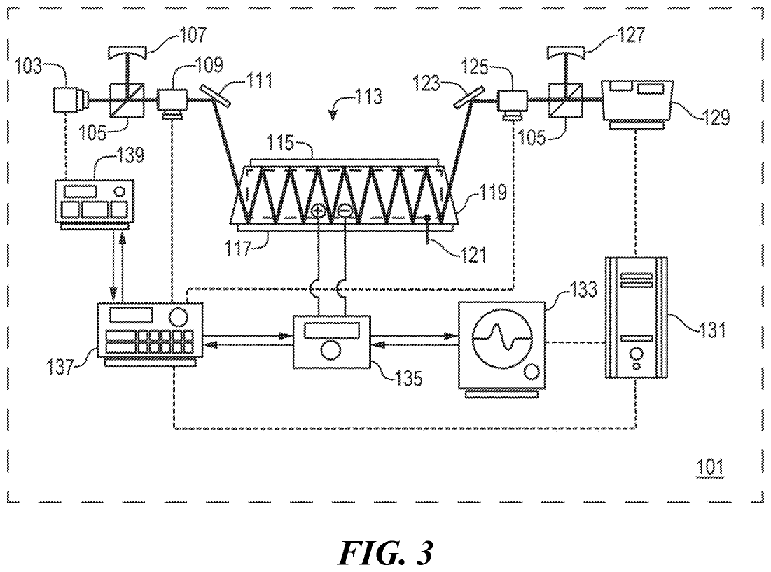

FIG. 3 depicts a diagram of a particular, non-limiting embodiment of a prototypical device in accordance with the teachings herein. The device 101 depicted therein comprises a laser diode 103, a beam splitter 105, a first stable resonator mirror 107, a first polarization rotator 109, a first mirror 111, a crystal medium 113 (comprising a nonlinear crystal 119 with first 115 and second 117 electrodes attached thereto and having an HV electric field region 121), a second mirror 123, a second polarization rotator 125, a second stable resonator mirror 127, a spectrophotometer 129, a data acquisition device 131, an oscilloscope 133, an HV (high voltage) pulser 135 equipped with a pulse multiplier, a pulse generator 137, and a diode laser driver 139.

The diode laser 103 may be any suitable laser. The beam splitter 105 splits the beam from the diode laser 103 into two beams. The first 107 and second 127 stable resonator mirrors operate in conjunction with the first 109 polarization rotator to cause the pulse to experience multiple passes through the crystal 119 following a zig-zag path. In particular, the first 109 polarization rotator rotates the polarization of the pulse (for example, by 90°) so it is trapped within the crystal medium 113. The second 125 polarization rotator rotates the polarization of the pulse so it escapes the crystal medium 113.

In operation, a pulse is created by the diode laser 103 and is injected into the system by opening the first polarization rotator 109. The pulse may then be removed from the system by opening the second polarization rotator 125. An electric field is applied as the pulse propagates through the system by way of the first 115 and second 117 electrodes. These electrodes are under the control of the HV pulser 135.

The pulse generator 137 provides synchronous pulses with appropriate delay by opening and closing the first 109 and second 125 polarization rotators and by controlling the pulse coming out of the diode laser 103. The pulse generator 137 also controls the HV pulser 135. The HV pulser 135 is triggered by an incoming pulse and multiplies the pulse into a train of high voltage pulses. The oscilloscope 133 cooperates with the data acquisition system 131 to characterize the performance of the system.

The particular prototypical device 101 depicted in FIG. 3 consists of two consecutive cells of externally driven nonlinear medium. Each cell may be expected to shift laser wavelength by approximately +/−20 nm. Thus, this device may be expected to provide a continuously variable shift in the range+/−40 nm. The device of FIG. 3 may be used in conjunction with a theoretical model of laser frequency shift due to externally induced time variation of the refractive index of nonlinear medium.

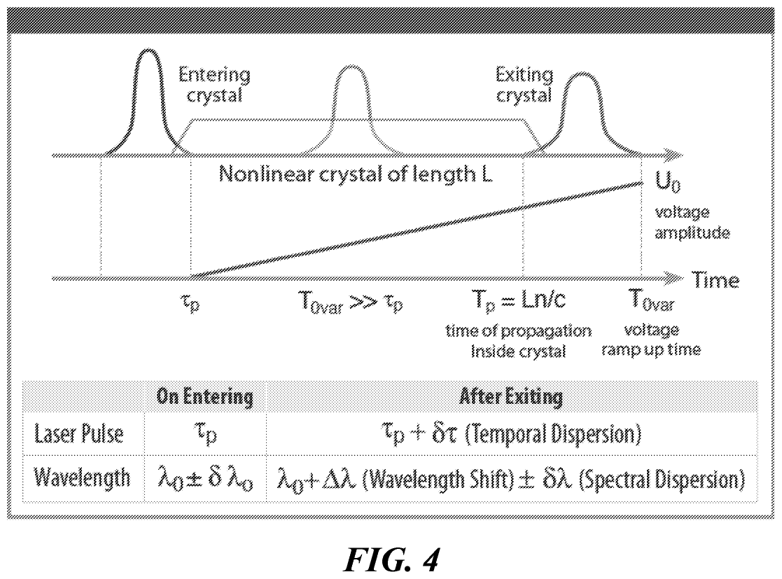

The heart of the device 101 of FIG. 3 is the crystal medium 113. In one embodiment, the crystal medium 113 consists of a nonlinear crystal 119 with first 115 and second 117 metallic electrodes deposited on the top and bottom plane surfaces of the crystal 119. The electrodes 115, 117 are connected to the HV pulse generator 137 by way of the pulser 135. In this embodiment, the HV pulse generator 137 produces l′ns pulses with a voltage amplitude of about 100 kV. The device 101 shifts the wavelength of the diode laser 103, thus generating pulses with variable duration in picosecond nanosecond range as shown in FIG. 4. Both the diode laser 103 and HV pulser 135 operate with a repetition rate in the range from 100 Hz to 1 kHz.

After passing through the nonlinear crystal 119, the output beam of the probe diode laser is analyzed with the spectrophotometer 129. Of course, one skilled in the art will appreciate that various devices may be fabricated in accordance with the teachings herein in which the output pulse is used for any desired purpose or use.

FIG. 4 depicts the relative time durations and the frequency change induced by the system of FIG. 3, and shows the laser pulse, voltage pulse ramp up, and time propagation through the crystal, with expected change in laser frequency and pulse shape. As seen therein, as the laser pulse propagates through the nonlinear crystal, a change in wavelength or frequency occurs.

It will be appreciated that the systems and methodologies described herein may be applied to laser systems having any pulse energy (e.g., low, medium, high, extra high) or power. By contrast, existing methodologies produce small pulse energies and cannot exceed certain energy levels (these systems thus produce limited power outputs).

It will also be appreciated that the systems and methodologies described herein may be applied to any mode composition. By contrast, current methods known to the art are typically applied to a single mode composition.

Any desired beam quality may be obtained using the systems disclosed herein. These include, for example, single mode, multimode, or supermultimode beam qualities. By contrast, typical existing systems may be applied only to very small pulse energies and to very high quality single mode beams.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

What is claimed is:

1. A method for modifying a wavelength of electromagnetic radiation that propagates through a medium, the method comprising:
providing a medium that exhibits a change in refractive index in response to a change in electric field;
impinging electromagnetic radiation from an electromagnetic radiation source onto the medium such that the electromagnetic radiation propagates through the medium; and
modifying at least one wavelength of the electromagnetic radiation propagating through the medium by externally inducing a temporal change in the refractive index of the medium.

2. The method of claim 1, wherein the electromagnetic radiation source is a laser.

3. The method of claim 2, wherein the laser is selected from the group consisting of high power and high pulse energy lasers.

4. The method of claim 2, wherein the electromagnetic radiation has an intensity exceeding 1×10¹³ W/cm².

5. The method of claim 2, wherein the laser produces pulse energies of at least 0.1 mJ.

6. The method of claim 2, wherein the laser produces pulse energies within the range of 0.1 to 1 mJ.

7. The method of claim 2, wherein the laser operates with a repetition rate in the range of 100 Hz to 1 kHz.

8. The method of claim 2, wherein the laser has an output power in excess of 1 kW.

9. The method of claim 2, wherein the laser has an output power in excess of 100 kW.

10. The method of claim 2, wherein the laser has an output power in excess of 200 kW.

11. The method of claim 10, wherein the electromagnetic radiation has pulse durations of less than 5 picoseconds.

12. The method of claim 7, wherein the change of the EMW frequency while propagating a distance dz in the medium due to changes in the index of refraction of the medium is given by
$${d}_{d z} ω = - \frac{2 π}{{λ}_{0}} \frac{d n ( z )}{d t} d z$$
where n(z) is the index of refraction, t is time, and λ₀ is the EMW wavelength in a vacuum.

13. The method of claim 6, wherein the medium exhibits the Pockels or Kerr electro-optic effect with respect to the electromagnetic radiation emitted by the electromagnetic radiation source.

14. The method of claim 6, wherein the medium has first and second sides, and wherein externally inducing a temporal change in the refractive index of the medium includes applying a controlled variable voltage to first and second sides of the medium.

15. The method of claim 14, wherein applying a controlled variable voltage to first and second sides of the medium produces a variable electric field inside of the medium.

16. The method of claim 15, wherein the variable electric field is linearly time dependent.

17. The method of claim 16, wherein the variable electric field increases linearly as a function of time.

18. The method of claim 17, wherein the spectrum of electromagnetic radiation emitted from the medium is shifted towards lower frequencies compared to the spectrum of electromagnetic radiation which impinges on the medium.

19. The method of claim 15, wherein the variable electric field decreases linearly as a function of time.

20. The method of claim 19, wherein the spectrum of electromagnetic radiation emitted from the medium is shifted towards higher frequencies compared to the spectrum of electromagnetic radiation which impinges on the medium.

21. The method of claim 16, wherein the medium is crystalline, and wherein, during the time (T) of electromagnetic radiation propagation through the optical path (Z) inside of the medium, the electromagnetic radiation frequency changes in accordance with
Δω=ω₀rn₀²E
where ω₀ is the frequency of the electromagnetic radiation when it impinges upon the medium, r is the constant for the nonlinear response of the medium to the electric field, and n₀ is the refractive index of the medium without electric field.

22. The method of claim 1, wherein the medium is a nonlinear crystal.

23. The method of claim 1, wherein the medium comprises LiNbO₃.

24. The method of claim 16, wherein the variable electric field both increases and decreases during propagation of the electromagnetic radiation through the medium.

25. The method of claim 24, wherein the frequency shift of the electromagnetic radiation emitted by the medium covers the visible portion of the spectrum.

26. The method of claim 25, wherein the frequency shift of the electromagnetic radiation emitted by the medium is greater than 75 Hz.

27. The method of claim 25, wherein the frequency shift of the electromagnetic radiation emitted by the medium is greater than 100 Hz.

28. The method of claim 25, wherein the frequency shift of the electromagnetic radiation emitted by the medium is greater than 125 Hz.

29. The method of claim 25, wherein the frequency shift of the electromagnetic radiation emitted by the medium is greater than 75 Hz.

30. The method of claim 1, wherein the medium is photoelastic, and wherein externally inducing a temporal change in the refractive index of the medium includes applying mechanical strain to the medium.

31. The method of claim 30, wherein applying mechanical strain to the medium includes applying an acoustical wave to the medium.

32. The method of claim 15, wherein the electromagnetic radiation source is a radio wave source.

33. The method of claim 1, wherein the electromagnetic radiation source is a LIDAR device.

34. The method of claim 1, further comprising:
multiplying the electromagnetic radiation from the electromagnetic radiation source into a train of pulses.

35. The method of claim 34, wherein the train of pulses has a voltage amplitude within the range of 50 kV to 150 kV.

36. The method of claim 34, wherein the train of pulses has a voltage amplitude within the range of 75 kV to 250 kV.

37. The method of claim 34, wherein the train of pulses has a voltage amplitude within the range of 90 kV to 110 kV.

38. The method of claim 34, wherein multiplying the electromagnetic radiation from the electromagnetic radiation source into a train of pulses creates synchronous pulses with a delay.

39. The method of claim 24, wherein multiplying the electromagnetic radiation from the electromagnetic radiation source into a train of pulses includes:
providing first and second polarization rotators in an optical path of the electromagnetic radiation; and
opening and closing the first and second polarization rotators.

40. The method of claim 34, wherein the source of electromagnetic radiation is a laser, and wherein multiplying the electromagnetic radiation from the electromagnetic radiation source into a train of pulses includes controlling the output of the laser.

41. The method of claim 1, wherein the source of electromagnetic radiation is a laser which emits a multimode beam.

42. A device for producing electromagnetic radiation of variable frequency, comprising:
a medium that exhibits a change in refractive index in response to a change in electric field;
a source of electromagnetic radiation which is in optical communication with said medium such that electromagnetic radiation from the source propagates through the medium; and
an inducing means for externally inducing a temporal change in the refractive index of the medium such that the frequency of electromagnetic radiation propagating through the medium is modified.

43. The device of claim 42, wherein the electromagnetic radiation source is a laser.

44. The device of claim 43, wherein the laser is selected from the group consisting of high power and high pulse energy lasers.

45. The device of claim 43, wherein the electromagnetic radiation has an intensity exceeding 1×10¹³ W/cm².

46. The device of claim 43, wherein the laser produces pulse energies of at least 0.1 mJ.

47. The device of claim 43, wherein the laser produces pulse energies within the range of 0.1 to 1 mJ.

48. The device of claim 43, wherein the laser operates with a repetition rate in the range of 100 Hz to 1 kHz.

49. The device of claim 43, wherein the laser has an output power in excess of 1 kW.

50. The device of claim 43, wherein the laser has an output power in excess of 100 kW.

51. The device of claim 43, wherein the laser has an output power in excess of 200 kW.

52. The device of claim 51, wherein the electromagnetic radiation has pulse durations of less than 5 picoseconds.

53. The device of claim 48, wherein the change of the EMW frequency while propagating a distance dz in the medium due to changes in the index of refraction of the medium is given by
$${d}_{d z} ω = - \frac{2 π}{λ} \frac{d n ( z )}{d t} d z$$
where n(z) is the index of refraction, t is time, and Do is the EMW wavelength in a vacuum.

54. The device of claim 47, wherein the medium exhibits the Pockels or Kerr electro-optic effect with respect to the electromagnetic radiation emitted by the electromagnetic radiation source.

55. The device of claim 47, wherein the medium has first and second sides, and wherein the means for externally inducing a temporal change in the refractive index of the medium includes first and second electrodes which apply a controlled variable voltage to the first and second sides of the medium.

56. The device of claim 55, wherein the inducing means produces a variable electric field inside of the medium.

57. The device of claim 56, wherein the variable electric field is linearly time dependent.

58. The device of claim 57, wherein the variable electric field increases linearly as a function of time.

59. The device of claim 58, wherein the spectrum of electromagnetic radiation emitted from the medium is shifted towards lower frequencies compared to the spectrum of electromagnetic radiation which impinges on the medium.

60. The device of claim 56, wherein the variable electric field decreases linearly as a function of time.

61. The device of claim 60, wherein the spectrum of electromagnetic radiation emitted from the medium is shifted towards higher frequencies compared to the spectrum of electromagnetic radiation which impinges on the medium.

62. The device of claim 57, wherein the medium is crystalline, and wherein, during the time (T) of electromagnetic radiation propagation through the optical path (Z) inside of the medium, the inducing means induces electromagnetic radiation frequency changes in accordance with
Δω=ω₀rn₀²E
where ω₀ is the frequency of the electromagnetic radiation when it impinges upon the medium, r is the constant for the nonlinear response of the medium to the electric field, and n₀ is the refractive index of the medium without electric field.

63. The device of claim 43, wherein the medium is a nonlinear crystal.

64. The device of claim 43, wherein the medium comprises LiNbO₃.

65. The device of claim 57, wherein the inducing means creates a variable electric field that both increases and decreases during propagation of the electromagnetic radiation through the medium.

66. The device of claim 65, wherein the frequency shift of the electromagnetic radiation emitted by the medium covers the visible portion of the spectrum.

67. The device of claim 66, wherein the frequency shift of the electromagnetic radiation emitted by the medium is greater than 75 Hz.

68. The device of claim 66, wherein the frequency shift of the electromagnetic radiation emitted by the medium is greater than 100 Hz.

69. The device of claim 66, wherein the frequency shift of the electromagnetic radiation emitted by the medium is greater than 125 Hz.

70. The device of claim 66, wherein the frequency shift of the electromagnetic radiation emitted by the medium is greater than 75 Hz.

71. The device of claim 42, wherein the medium is photoelastic, and wherein the inducing means externally induces a temporal change in the refractive index of the medium by applying mechanical strain to the medium.

72. The device of claim 71, wherein applying mechanical strain to the medium includes applying an acoustical wave to the medium.

73. The device of claim 56, wherein the electromagnetic radiation source is a radio wave source.

74. The device of claim 42, wherein the electromagnetic radiation source is a LIDAR device.

75. The device of claim 42, further comprising:
a pulse multiplier which multiplies the electromagnetic radiation from the electromagnetic radiation source into a train of pulses.

76. The device of claim 75, wherein the train of pulses has a voltage amplitude within the range of 50 kV to 150 kV.

77. The device of claim 75, wherein the train of pulses has a voltage amplitude within the range of 75 kV to 250 kV.

78. The device of claim 75, wherein the train of pulses has a voltage amplitude within the range of 90 kV to 110 kV.

79. The device of claim 75, wherein multiplying the electromagnetic radiation from the electromagnetic radiation source into a train of pulses creates synchronous pulses with a delay.

80. The method of claim 75, wherein the pulse multiplier multiplies the electromagnetic radiation from the electromagnetic radiation source into a train of pulses by opening and closing the first and second polarization rotators disposed in an optical path of the electromagnetic radiation.

81. The device of claim B34, wherein the source of electromagnetic radiation is a laser, and wherein the pulse multiplier also controls the output of the laser.

82. The device of claim 42, wherein the source of electromagnetic radiation is a laser which emits a multimode beam.
